(19) United States
(12) Patent Application Publication
(10) Pub. No.: US 2017/0023672 A1
(43) Pub. Date: Jan. 26, 2017

(54) HYBRID DISTRIBUTED ANTENNA SYSTEM AND MOTION DETECTION SECURITY RADAR

(71) Applicant: COMMCOPE TECHNOLOGIES LLC, Hickory, NC (US)

(72) Inventor: Charles B. Morrison, Forest, VA (US)

(21) Appl. No.: 15/302,354

(22) PCT Filed: Aug. 7, 2014
(86) PCT No.: PCT/US14/50115

§ 371 Date: Oct. 6, 2016

Related U.S. Application Data
(60) Provisional application No. 61/977,154, filed on Apr. 9, 2014.

(51) Int. Cl. G01S 13/88; G01S 13/00; G01S 13/87; G01S 13/56

(52) U.S. Cl. CPC G01S 13/886; G01S 13/56; G01S 13/003; G01S 13/87

(57) ABSTRACT

Certain features relate to using a distributed antenna system as a hybrid system for providing wireless communications coverage and operating in a radar security mode. A remote unit is configured for extending wireless communications coverage by communicating signals between a head-end unit and one or more user equipment devices located within the remote unit's coverage area. The remote unit can be configured to obtain motion detection radar information based on movement of persons or objects located within the coverage area of the remote unit. The hybrid distributed antenna system can be configured to selectively operate between modes of providing wireless coverage and providing radar security.

### CROSS-REFERENCE TO RELATED APPLICATIONS

This application is a U.S. National Stage Application of PCT Application Serial No. PCT/US2014/050115, filed Aug. 7, 2014, and titled “HYBRID DISTRIBUTED ANTENNA SYSTEM AND MOTION DETECTION SECURITY RADAR”, which claims the benefit of U.S. Provisional Application Serial No. 61/977,154, filed Apr. 9, 2014 and titled “HYBRID DISTRIBUTED ANTENNA SYSTEM AND MOTION DETECTION SECURITY RADAR SYSTEM”, the contents of all of which are hereby incorporated by reference.

### TECHNICAL FIELD

The present disclosure relates generally to telecommunications systems and more particularly (although not necessarily exclusively) to distributed antenna systems that can be configured to provide wireless communications coverage and motion detection security.

### BACKGROUND

A distributed antenna system (“DAS”) can include one or more head-end units and multiple remote units coupled to each head-end unit. A DAS can be used to extend wireless coverage in an area. Head-end units can be connected to base stations. A head-end unit can receive downlink signals from the base station and distribute downlink signals in analog or digital format to one or more remote units. The remote units can transmit the downlink signals to user equipment devices within coverage areas serviced by the remote units. In the uplink direction, signals from user equipment devices may be received by the remote units. The remote units can transmit the uplink signals received from user equipment devices to a head-end unit. The head-end unit can transmit uplink signals to the serving base stations.

Often buildings and other structures have many different systems in addition to a DAS. Having many different systems can be expensive and introduce complications during installation, maintenance, and operation through lost opportunities such as a system being unoperated during certain times.

### SUMMARY

Certain aspects and features are directed to hybrid distributed antenna systems that can be configured to provide wireless communications coverage and be used as motion detection security radar.

In one aspect, a hybrid distributed antenna system and motion detection security radar system is provided. The hybrid distributed antenna system and motion security radar system can include a head-end unit and a remote unit configured for communicatively coupling to the head-end unit. The remote unit can provide wireless communications service within a coverage area. The remote unit can also obtain motion detection radar information associated with an object or person located within the coverage area. The motion detection radar information can be used by the head-end unit to determine a security condition in the coverage area.

In another aspect, a remote unit of a hybrid distributed antenna system and motion detection security radar system is provided. The remote unit can include one or more channels configured for selectively operating between a DAS mode or a radar security mode. The one or more channels can be configured to operate in the DAS mode by providing wireless communications service within a coverage area. The one or more channels can be configured to operate in the radar security mode by obtaining motion detection radar information associated with an object or person located within the coverage area.

In another aspect, a method for using a distributed antenna system as a motion detection security radar is provided. The method can include providing wireless communications service within a coverage area while operating in a DAS mode. The method can also include obtaining motion detection radar information associated with movement of an object or person located within the coverage area when operating in a radar security mode. The method can also include receiving the motion detection radar information and determining a security condition based on the motion detection radar information when operating in the radar security mode.

These illustrative aspects and features are mentioned not to limit or define the disclosure, but to provide examples to aid understanding of the concepts disclosed in this application. Other aspects, advantages, and features of the present disclosure will become apparent after review of the entire application.

### BRIEF DESCRIPTION OF THE DRAWINGS

FIG. 1 is a block diagram depicting an example of a base station and a hybrid distributed antenna system that can provide wireless coverage and motion detection security according to one aspect of the present disclosure.

FIG. 2 is a block diagram depicting an example of a remote unit of FIG. 1 according to one aspect of the disclosure.

FIG. 3 is a block diagram depicting an example of a remote unit of FIG. 1, configured as a monostatic continuous wave Doppler radar according to one aspect of the disclosure.

FIG. 4 is a block diagram depicting an example of two remote units of FIG. 1 in a bistatic continuous wave Doppler radar configuration according to one aspect of the disclosure.

FIG. 5 is a block diagram depicting an example of the remote unit of FIG. 1, configured as a monostatic rake receiver according to one aspect of the disclosure.

FIG. 6 is a block diagram depicting an example of two remote units of FIG. 1 in a bistatic rake receiver configuration according to one aspect of the disclosure.

FIG. 7 is a flow chart depicting a process for using a hybrid distributed antenna system and motion detection system according to one aspect of the present disclosure.

### DETAILED DESCRIPTION

Certain aspects and features relate to using a distributed antenna system (“DAS”) as a motion detection security radar. A DAS can provide a signal transport network for communicating signals between one or more base stations and user equipment devices or other terminal devices. A DAS can thus provide extended communication coverage beyond the immediate vicinity of the base station. However, certain facilities, such as office buildings, in which DASs can be deployed may be occupied during certain hours of the day and unoccupied during other hours. During off hours the utilization of the DAS for providing wireless coverage can be significantly less than during regular hours. During the off hours when the building is likely to be unoccupied, it may be desirable to secure the facility using a motion detection security radar system that can indicate the presence of intruders. According to certain aspects and features, a hybrid DAS and motion detection security radar system can selectively operate between a DAS mode (e.g., providing wireless coverage) and a radar security mode.

When the DAS operates in the DAS mode, voice or data traffic can be sent or received between remote units in communication coverage areas, one or more expansion units, and one or more head-end units. When the DAS operates in the radar security mode, one or more transceiver channels in the remote units may be used for receiving motion detection radar information. The motion detection radar information can be associated with movement of an object or person located within a coverage area served by the remote unit. The motion detection radar information can be transmitted to a head-end unit or an expansion unit from the remote unit. The head-end unit or the expansion unit can determine a security condition based on the motion detection radar information. In the radar security mode, voice or data traffic may be transmitted on transceiver channels not used for receiving motion detection radar information, transmitted at reduced speed or power, or not transmitted.

Detailed descriptions of certain examples are discussed below. These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure.

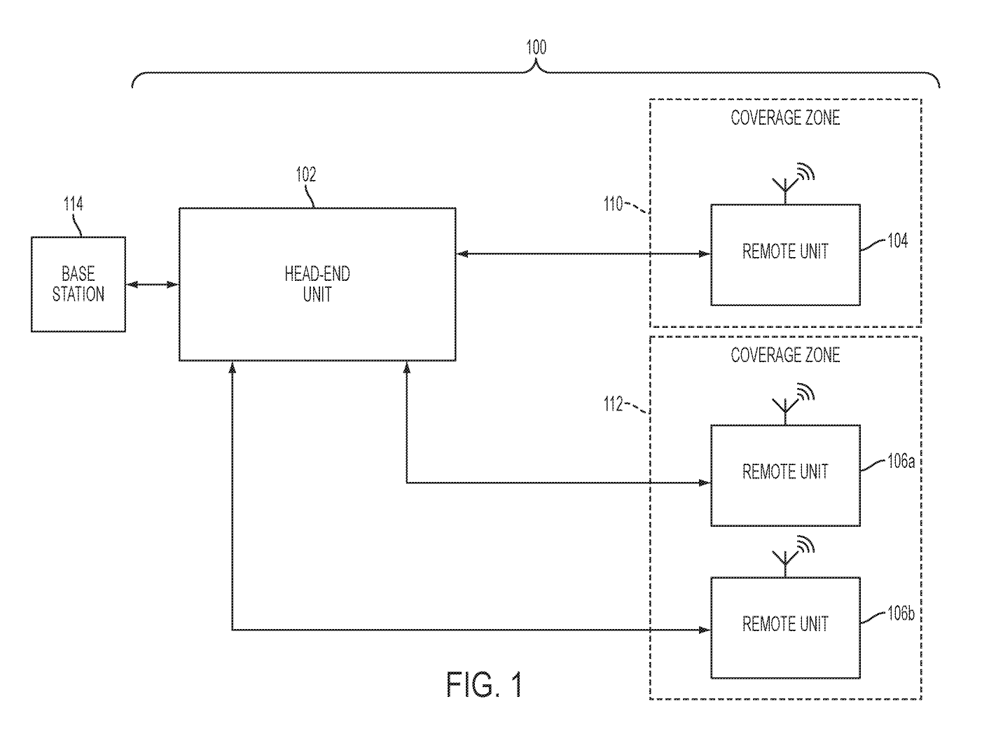

FIG. 1 is a block diagram depicting an example of a DAS 100 that can include remote units 104, 106a-b for communicating with a base station 114 according to one aspect. The remote units 104, 106a-b can provide signal coverage to user equipment devices positioned in respective coverage zones 110, 112.

The head-end unit 102 can receive downlink signals from a base station 114 and transmit uplink signals to the base station 114. Any suitable communication link can be used for communication between the base station 114 and the head-end unit 102, such as (but not limited to) a direct connection or a wireless connection. A direct connection can include, for example, a connection via a copper, optical fiber, or other suitable communication medium. In some aspects, the head-end unit 102 can include an external repeater or internal RF transceiver included on a donor card to communicate with the base station 114. In some aspects, the head-end unit 102 can combine downlink signals received from different base station 114. The head-end unit 102 can transmit the combined downlink signals to one or more of the remote units 104, 106a-b.

The remote units 104, 106a-b can provide signal coverage in coverage zones 110 and 112 by transmitting downlink signals to user equipment devices and receiving uplink signals from the user equipment devices. The remote units 104, 106a-b can transmit uplink signals to the head-end unit 102. The head-end unit 102 can combine uplink signals received from the remote units 104, 106a-b for transmission to the base station 114.

For illustrative purposes, FIG. 1 depicts a DAS 100 that communicates with one base station 114 and that includes a single head-end unit 102 and three remote units 104, 106a-b serving two coverage zones 110 and 112. A DAS according to various aspects and features can communicate with any number of base stations and can include any suitable number of head-end units and remote units. A DAS can also serve any number of coverage zones.

In a non-limiting example, the remote unit 104 can be configured to, such as by being designed to, provide signal coverage to user equipment devices in coverage zone 110. Remote unit 104 can also be configured to provide motion detection security radar in coverage zone 110. Remote unit 104 can be configured to selectively operate in DAS mode (providing signal coverage) or motion detection security radar mode. In another non-limiting example, two or more remote units 106a-b can be configured to provide signal coverage to user equipment devices in one coverage zone 112. Two or more remote units 106a-b can also be configured to selectively operate in DAS mode (providing signal coverage) or motion detection security radar mode.

A DAS can be configured in various ways to operate as a radar system. A remote unit may contain multiple, independent, software-defined transceiver channels. For example, a remote unit can contain multiple (e.g., four) transceiver channels configured to receive downlink RF signals from a head-end unit and transmit uplink RF signals to the head-end unit. Each transceiver channel in a remote unit can also be configured to receive motion detection radar signals.

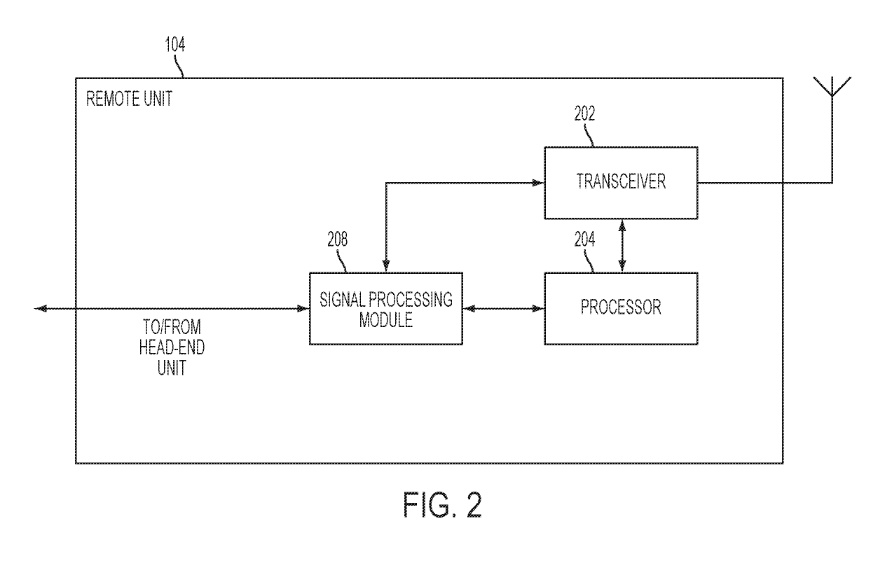

FIG. 2 is a block diagram depicting an example of the remote unit 104 according to one aspect. An example of the remote unit 104 is a universal access point (UAP). The example remote unit 104 can include a transceiver 202, a signal processing module 208, and a processor 204. Remote unit 104 can wirelessly transceive signals with mobile user equipment or devices for providing wireless communications service in a coverage area.

In the DAS mode, channels in transceiver 202 can be linked through a communications link to head-end unit 102. Any suitable communication link can be used between the remote unit 104 and head-end unit 102, such as (but not limited to) a wired connection or a wireless connection. A wired connection can include, for example, a connection via a copper cable, an optical fiber, or another suitable communication medium. A wireless connection can include, for example, a wireless RF communication link. Linking the transceiver channels can allow downlink signals to be retransmitted from base stations (coupled to the head-end unit) to the remote unit. Conversely, linking the transceiver channels can allow uplink signals to be routed from the remote unit, through the head-end unit, to the base station uplink input.

The processor 204 can include any device suitable for executing program instructions to control operation of the remote unit 104. Examples of processor 204 include a microprocessor, an application-specific integrated circuit (“ASIC”), a field-programmable gate array (“FPGA”), or other suitable processor. The processor 204 may include one processor or any number of processors. The processor 204 can be configured to execute a suitable algorithm for determining whether to selectively operate in a DAS mode or in a radar detection mode.

The remote unit 104 can communicate with the head-end unit 102 via any suitable signal processing module 208, such as (but not limited to) a physical layer transceiver or other suitable component configured for communicating with a head-end unit 102. The signal processing module 208 can process uplink and downlink signals for communication with the head-end unit 102. The signal processing module 208 can include one or more digital components or devices, one or more analog components or devices, or any combination thereof for communicating signals between the remote unit 104 and the head-end unit 102. For example, the signal processing module 208 can include one or more digital signal processors, one or more filters, one or more digital-to-analog converters, one or more analog-to-digital converters, etc. Examples of signal processing module 208 can also include a microprocessor, an application-specific integrated circuit, an FPGA, or other suitable processor. When operating in DAS mode, the signal processing module 208 can convert digital downlink signals received from a head-end unit 102 into analog downlink signals to be provided from the remote unit 104 to user equipment devices in the coverage zone 110.

One or more of the transceiver channels may be configured at a certain time (e.g., during off hours) to operate as radar motion sensors. As an example, remote unit 104 can be configured to operate as a radar motion sensor by being designed to do so or in response to receiving commands from a controller or other unit. The commands can include commands to execute different software instructions or to modify the hardware in the remote unit. Remote units can be dynamically configured to operate in either the DAS mode, the radar security mode, or a combination of both modes. For example, a remote unit can be configured to operate in the radar security mode until wireless communications traffic exceeds a threshold value and more wireless communications capacity is needed. Remote units can also be configured to operate in either the DAS mode, the radar security mode, or a combination of both modes based on a preconfigured schedule. For example, a remote unit can be configured to operate in the DAS mode during a first predetermined time period (e.g., work hours) and to operate in the radar security mode during a second predetermined time period (e.g., non-work hours). Some examples for implementing a radar motion sensor using remote unit hardware are described below, but these examples are not intended to be exhaustive or limiting.

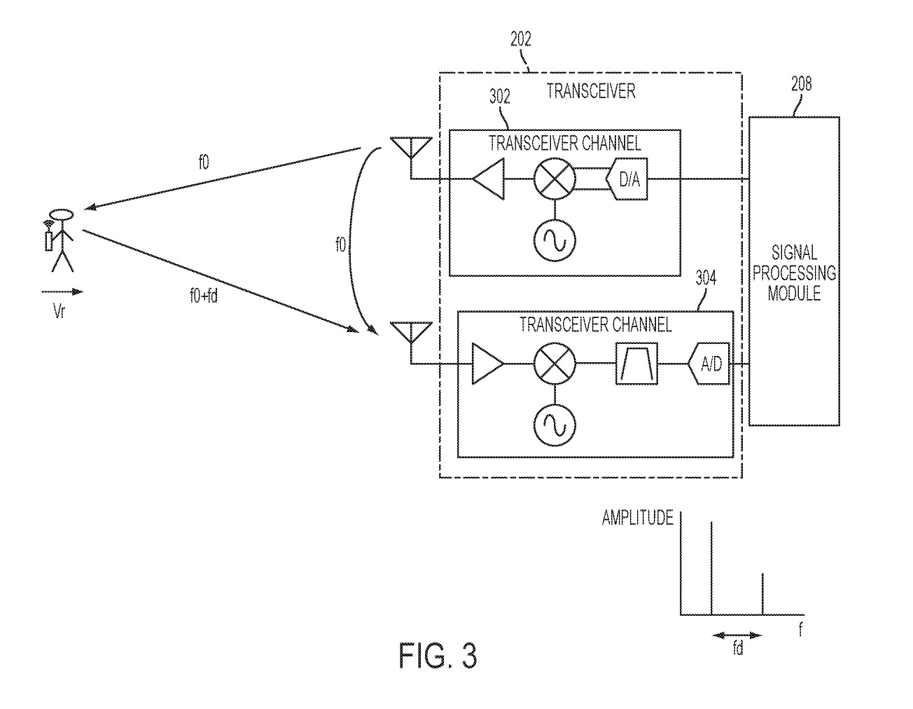

FIG. 3 shows an example of a diagram of remote unit 104 configured as a monostatic continuous wave (CW) Doppler radar. Transceiver 202 can include transceiver channels 302 and 304. Transceiver channel 302 can be configured to emit a constant CW tone at frequency f₀. Transceiver channel 304 can be configured to receive a band of frequencies around f₀ The receive spectrum can contain a component due to the direct reception of the transmitter. The receive spectrum can also contain components due to the transmit signal scattering from targets in the vicinity. If a target has a velocity relative to the remote unit of Vᵣ, the frequency of the scattered signal can be shifted due to the Doppler effect by a frequency of:

$${f}_{d} = \frac{2 {V}_{r} {f}_{0}}{c}$$

As used herein, c refers to the speed of light in a vacuum and has an approximate value of 299,792,458 meters per second. For example, a walking intruder target traveling at 1.5 m/s and an RF frequency of 2500 MHz, the Doppler frequency may be 25 Hz. Signal processing can be performed by the remote unit by signal processing module 208. For example, an FPGA in a remote unit can distinguish received signals with an appropriate Doppler shift from signals with no Doppler shift associated with a component due to the direct reception of the transmitter. If the amplitude of Doppler-shifted signals exceed an appropriate threshold, an alarm can be determined, generated, or provided. For example, the alarm can be communicated to the head-end unit or other device for output to a user or to a separate device with suitable alarm output capabilities.

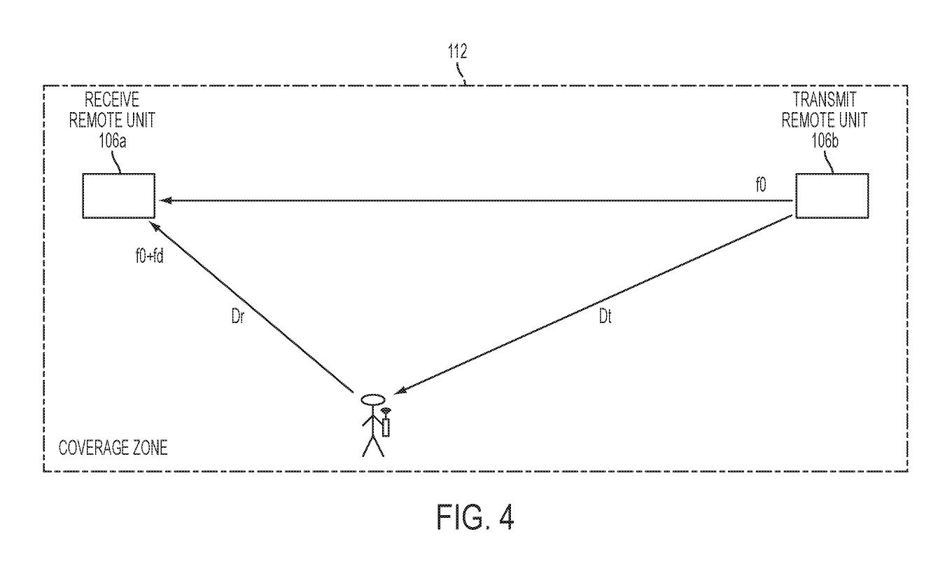

FIG. 4 shows an example of remote units 106a-b configured for bistatic radar in coverage zone 112 according to an example of the subject matter. If the area to be protected contains more than one remote unit, the receiving antennas and the transmitting antennas can be deployed in different locations. Remote unit 106b can be configured as a transmit remote unit and remote unit 106a can be configured as a receive remote unit.

As in the monostatic implementation, a channel of the four transceiver channels in the transmitting remote unit 106b can be configured to emit a constant CW tone at frequency f₀. A transceiver channel in the receiving remote unit 106a can be configured to receive a band of frequencies around f₀. The receive spectrum can contain a component due to the direct reception of the transmitter and components due to the transmit signal scattering from targets in the vicinity. If targets are moving, the scattered signal can be shifted in frequency due to the Doppler effect. The Doppler frequency can be proportional to the time rate of change of the total path length of the scattered signal, given by the formula below:

$${f}_{d} = \frac{{f}_{0}}{c} \cdot \vert \frac{d}{d t} ( {D}_{t} + {D}_{r} ) \vert$$

As in the monostatic case, signal processing can be implemented in the receiving remote unit's signal processing module, which can distinguish received signals having an appropriate Doppler shift from the direct transmitter component. If the amplitude of Doppler shifted signals exceeds an appropriate threshold, an alarm can be asserted and communicated (e.g., transmitted back to the head-end unit).

In examples in which more than two remote units are deployed, the remote units designated as transmitters and receivers can be determined based on coverage needs. Multiple channels can be used within the remote unit, allowing for a mix of transmitters and receivers in the same remote unit.

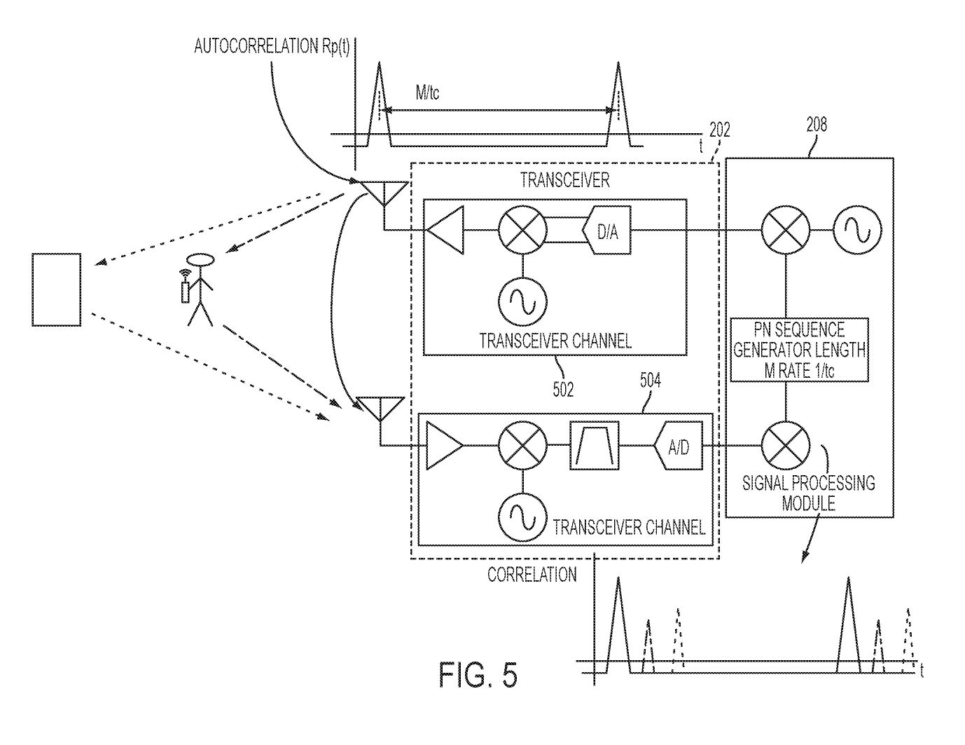

FIG. 5 shows, as an example, a diagram of remote unit 104 configured as a monostatic rake receiver according to an example of the subject matter. FIG. 5 includes an implementation using a transmit signal modulated with a pseudo-noise signal. Any suitable modulation scheme can be used to transmit the pseudo-noise modulated signal. For example, modulation techniques can include phase-shift keying, frequency shift keying, amplitude shift keying, or quadrature amplitude modulation. Transceiver 202 can include transceiver channels 502 and 504. Transceiver channel 502 can be configured to a transmit signal modulated with a pseudo-noise signal. Transceiver channel 504 can be configured to receive signals sent from transceiver channel 502 and signals scattered from reflectors in the vicinity of remote unit 104.

Using a transmit signal modulated with a pseudo-noise signal may be desirable, for example, if the frequency of operation is within an unlicensed band in which regulatory requirements prohibit CW emissions. The pseudo-noise signal can be designed such that its autocorrelation function has a peak at lags of zero or multiples of the signal period, and at other lag values the autocorrelation is small. As used herein, an autocorrelation function or autocorrelation refers to a mathematical representation of the degree of similarity between a given time series and a lagged version of itself over successive time intervals (a/k/a lag values). Autocorrelation is the cross-correlation of a signal with itself. The modulated signal can be radiated from the remote unit transmit antenna. The receive antenna can collect the signal directly sent from the transmitter and signals scattered from reflectors in the remote unit's vicinity. The arrival time of each scattered signal can be proportional to the distance of each reflector from the remote unit. If the received signal is cross-correlated with the transmit pseudo-noise sequence, unique correlation peaks can appear at different relative times corresponding to each of the nearby reflectors. A change in the time position of a correlation peak can indicate a change in radial distance of a reflector from the remote unit. Motion in the protected area can be detected, triggering an appropriate alarm to be communicated to the head-end unit.

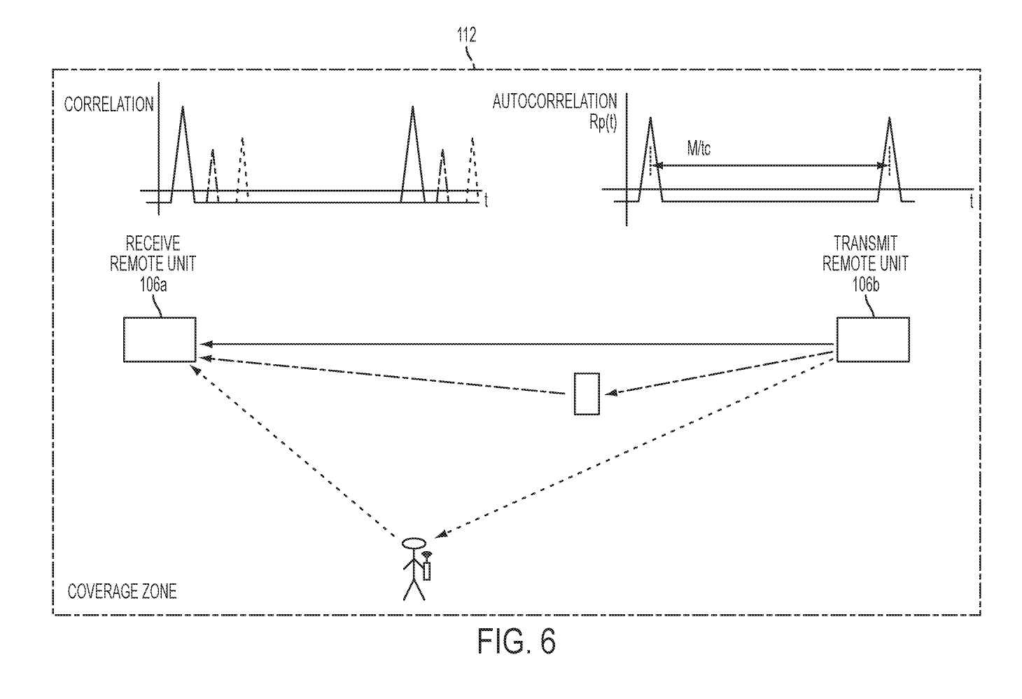

FIG. 6 shows an example of remote units 106a-b configured for multistatic rake receiver radar in coverage zone 112 according to an example of the subject matter described herein. Similar to a multistatic CW Doppler radar implementation, the rake receiver can be implemented with the transmitter and the receiver being located in separate remote units, as shown in FIG. 6. Remote unit 106b can be configured as a transmit remote unit and remote unit 106a can be configured as a receive remote unit. Remote unit 106b can include a transceiver configured to transmit a signal modulated with a pseudo-noise signal. Remote unit 106a can include a transceiver configured to receive signals sent from remote unit 106b and signals scattered from reflectors in coverage zone 112. The relative time positions of correlation peaks can be proportional to the total path length of the transmitted and scattered signal. Changes in the time position of the relative time positions of correlation peaks can indicate motion in the protected area and can trigger an alarm that can be communicated to a head-end unit.

The subject matter described herein is not limited to the radar implementations described above and may include other possibilities of detecting intruders using motion detection radar.

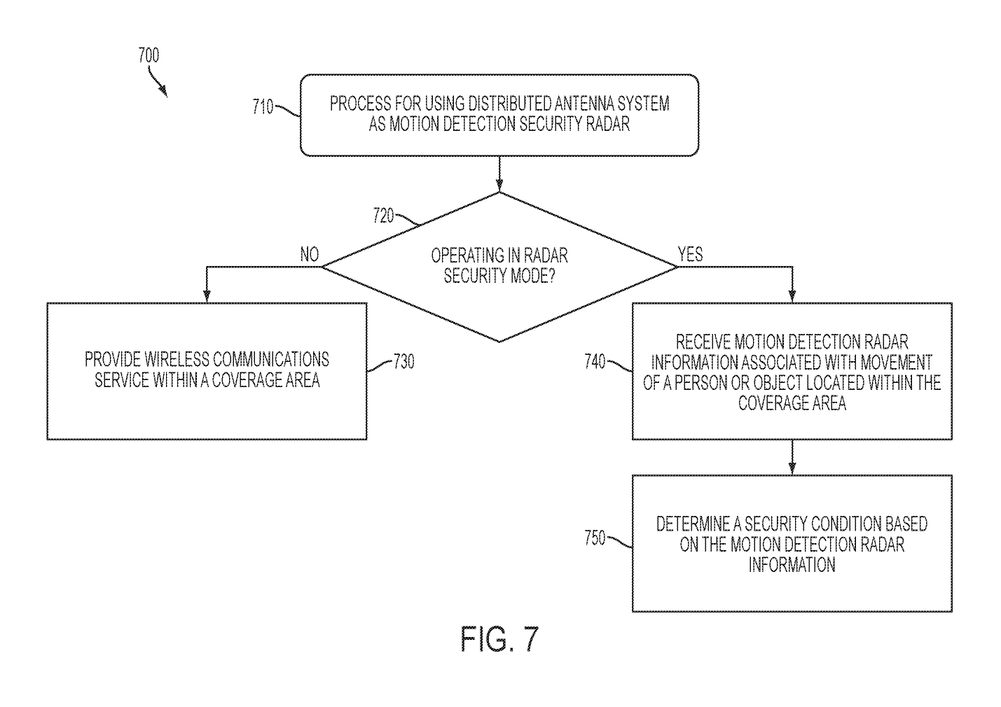

FIG. 7 is a flow chart depicting a process 700 for using a hybrid motion detection system and motion detection radar information according to one aspect of the present disclosure. The process 700 is described with respect to the system depicted in FIG. 1. Other implementations, however, are possible.

In block 720, a controller in the distributed antenna system determines if the distributed antenna system is operating in a radar security mode. In a non-limiting example, a controller can be a processor 204 in remote unit 104. A controller that determines if the distributed antenna system is operating in a radar security mode can also be included in a head-end unit 102. In block 730, the distributed antenna system can be configured to provide wireless communications within a coverage area when the distributed radar system is not operating in a radar security mode. For example, remote unit 104 can be configured to provide wireless coverage by transmitting downlink RF signals from a head-end unit 102 to user equipment devices in coverage zone 110. While providing wireless communications, remote unit 104 can also transmit uplink signals from the user equipment devices to the head-end unit 102.

In block 740, when operating in radar security mode, motion detection radar information associated with movement of a person or object located within a coverage area can be received. For example, a remote unit 104 can be configured to receive motion detection radar information by implementing a monostatic continuous wave Doppler radar or monostatic rake receiver as discussed above. Multiple remote units 106a-b in a coverage zone 112 can be configured to receive motion detection radar information by implementing a bistatic continuous wave Doppler radar or bistatic rake receiver as discussed above.

In block 750, a security condition can be determined based on the motion detection radar information when operating in radar security mode. An example of a security condition can include an alarm that is determined, generated, or provided when motion detection radar information exceeds an appropriate threshold. For example, a security condition can include an alarm that is generated when the amplitude of Doppler shifted signals exceed an appropriate threshold in a monostatic or bistatic continuous wave Doppler radar. The security condition can be generated by processor 204 or signal processing module 208 in remote unit 104. The security condition determined in remote unit 104 can be communicated to head-end unit 102. In another aspect, motion detection security information obtained in remote unit 104 can be communicated to head-end unit 102. The security condition can be generated by the head-end unit 102.

The foregoing description of the examples, including illustrated examples, of the disclosed subject matter has been presented only for the purpose of illustration and description and is not intended to be exhaustive or to limit the subject matter to the precise forms disclosed. Numerous modifications, adaptations, and uses thereof can be apparent to those skilled in the art without departing from the scope of this subject matter. The illustrative examples described above are given to introduce the reader to the general subject matter discussed here and are not intended to limit the scope of the disclosed concepts.

What is claimed is:

1. A hybrid distributed antenna system and motion detection security radar system, comprising:
a head-end unit; and
a remote unit configured for communicatively coupling to the head-end unit, providing wireless communications service within a coverage area, and obtaining motion detection radar information associated with an object or person located within the coverage area, the motion detection radar information being usable by the head-end unit for determining a security condition in the coverage area.

2. The hybrid distributed antenna system and motion detection security radar system of claim 1 wherein the remote unit or the head-end unit is further configured for selectively operating in either a DAS mode or a radar security mode.

3. The hybrid distributed antenna system and motion detection security radar system of claim 2, wherein the remote unit or the head-end unit is configured to operate in the DAS mode by:
communicating downlink signals received from the head-end unit to a user equipment device located within the coverage area via the remote unit; and
communicating uplink signals received from the user equipment device to the head-end unit via the remote unit.

4. The hybrid distributed antenna system and motion detection security radar system of claim 2 wherein the remote unit or the head-end unit is configured to operate in the radar security mode during a designated time period.

5. The hybrid distributed antenna system and motion detection security radar system of claim 1, wherein the head-end unit is configured for determining the security condition by determining if the motion detection radar information exceeds a threshold value.

6. The hybrid distributed antenna system and motion detection security radar system of claim 1, wherein the remote unit is configured to obtain the motion detection radar information by:
configuring a transmit channel to transmit a continuous wave tone at a first frequency;
configuring a receive channel to receive a band of frequencies centered around the first frequency; and
performing signal processing on the band of frequencies centered around the first frequency to determine an amplitude of a Doppler shifted signal.

7. The hybrid distributed antenna system and motion detection security radar system of claim 6, wherein the transmit channel and the receive channel are located in either the same remote unit or separate remote units within the coverage area.

8. The hybrid distributed antenna system and motion detection security radar system of claim 1, wherein the remote unit is configured to obtain the motion detection radar information by transmitting a pseudo-noise modulated signal and receiving a plurality of signals via a monostatic rake receiver.

9. The hybrid distributed antenna system and motion detection security radar system of claim 1, wherein the remote unit is configured to obtain the motion detection radar information by receiving a plurality of signals via a multistatic rake receiver.

10. A remote unit of a hybrid distributed antenna system and motion detection security radar system, the remote unit comprising:
one or more channels configured for selectively operating between a DAS mode by providing wireless communications service within a coverage area or a radar security mode by obtaining motion detection radar information associated with an object or person located within the coverage area.

11. The remote unit of the hybrid distributed antenna system and motion detection security radar system of claim 10, wherein the one or more channels are further configured to operate in the DAS mode during a first time period and to operate in the radar security mode during a second time period.

12. The remote unit of the hybrid distributed antenna system and motion detection security radar system of claim 10, wherein the one or more channels are configured to obtain motion detection radar information by:
transmitting a continuous wave tone at a first frequency using a first channel;
receiving a band of frequencies centered around the first frequency using a second channel; and
performing signal processing on the band of frequencies centered around the first frequency to determine an amplitude of a Doppler shifted signal.

13. The remote unit of the hybrid distributed antenna system and motion detection security radar system of claim 10, wherein the one or more channels are configured to obtain motion detection radar information by modulating a transmit signal with a pseudo-noise signal and receiving a plurality of signals via a monostatic rake receiver.

14. The remote unit of the hybrid distributed antenna system and motion detection security radar system of claim 10, wherein the one or more channels are configured to obtain motion detection radar information by receiving a plurality of signals via a multistatic rake receiver.

15. A method for using a distributed antenna system as a motion detection security radar, comprising:
providing wireless communications service within a coverage area while operating in a DAS mode;
obtaining motion detection radar information associated with movement of an object or person located within the coverage area while operating in a radar security mode;
determining a security condition based on the motion detection radar information while operating in the radar security mode.

16. The method of claim 15, further comprising:
selectively operating in either the DAS mode or the radar security mode.

17. The method of claim 15, wherein a remote unit or a head-end unit communicatively coupled to the remote unit is configured to operate in the radar security mode during a designated time period.

18. The method of claim 15, wherein a remote unit or a head-end unit communicatively coupled to the remote unit is configured to determine the security condition by determining if the motion detection radar information exceeds a threshold value.

19. The method of claim 15, wherein a remote unit obtains the motion detection radar information via either a monostatic or multistatic continuous wave Doppler radar.

20. The method of claim 15, wherein a remote unit obtains the motion detection radar information via either a monostatic or multistatic rake receiver.
